(19) United States
(12) Patent Application Publication
(10) Pub. No.: US 2023/0222343 A1
(43) Pub. Date: Jul. 13, 2023

(54) CONTROL METHOD AND SYSTEM BASED ON LAYER-WISE ADAPTIVE CHANNEL PRUNING

(71) Applicant: SAMSUNG ELECTRONICS CO., LTD., Suwon-si (KR)

(72) Inventors: CHAN-HYUN YOUN, Daejeon (KR); Minsu Jeon, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 18/073,269

(22) Filed: Dec. 1, 2022

(30) Foreign Application Priority Data
Jan. 10, 2022 (KR) 10-2022-0003399

(51) Int. Cl. G06N 3/08; G06N 3/04

(52) U.S. Cl. CPC G06N 3/082; G06N 3/04

(57) ABSTRACT

A control method and system based on layer-wise adaptive channel pruning are provided. The control method includes: profiling a layer-wise pruning sensitivity of an original deep-learning model; comparing an influence of a resource memory occupancy reduction on a throughput of an accelerator resource with an influence of a computation amount reduction on the throughput of the accelerator resource; performing, based on the comparing, a channel pruning based on a model layer-wise resource memory occupancy characteristic of the original deep-learning model or a model layer-wise computation amount characteristic of the original deep-learning model; in response to the channel-pruned model satisfying a certain model analysis accuracy level, determining a batch size for the accelerator resource; and in response to a throughput of the channel-pruned model based on the determined batch size being greater than a throughput of the original deep-learning model, employing the channel-pruned model in the deep-learning model computation acceleration.

### CROSS-REFERENCE TO RELATED APPLICATION

This application claims priority from Korean Patent Application No. 10-2022-0003399 filed on Jan. 10, 2022 in the Korean Intellectual Property Office, and all the benefits accruing therefrom under 35 U.S.C. 119, the contents of which in its entirety are herein incorporated by reference.

### BACKGROUND

### Field

The present disclosure relates to a control method and system based on layer-wise adaptive channel pruning.

The present disclosure relates to a channel pruning control technique of a deep neural network (DNN) for accelerating inference computation of a deep-learning model. More specifically, the present disclosure relates to a layer-wise adaptive channel pruning control scheme of DNN that may be optimized for computation characteristics of an accelerator available in a computing cluster environment so as to maximize a service throughput of the available accelerator while satisfying a given service processing latency and model analysis accuracy of the model.

### Description of Related Art

Deep-learning model network pruning refers to a technique of removing some unnecessary links among all links constituting deep-learning model computation. Based on a type of a link as removed, this pruning scheme is largely classified into weight pruning in which the link is removed based on an individual computation parameter (for example, weight), and channel pruning in which the link is removed based on an output channel of each layer.

In the weight pruning, the link is removed on a weight parameter basis, wherein the weight parameter is a minimum unit of each computation. As the link is removed on a searchable minimum parameter basis, the weight pruning exhibits robustness against performance degradation of the model which is generally represented by accuracy, compared to the channel pruning.

However, the weight pruning removes the link on the individual parameter basis. Thus, in order to achieve acceleration via substantial parameter size reduction and computation amount reduction in processing of layer-wise computation, a sparse matrix computation support software library or hardware support considering the same may be required. However, even when such supports exist, an effect thereof is not great.

On the other hand, in the channel pruning, the link is removed on the output channel unit of each layer basis. While the individual output channel of each layer is removed, all computations connected to the corresponding channel (for example, regarding a convolutional layer, all connected kernel filters, and regarding a fully connected layer, all connected weights) may be replaced with the same type of layer computation that is small in scale to be removed.

Due to these characteristics, the channel pruning may achieve acceleration via reduction of a parameter size and a computation amount as much as a channel removal amount without separate software and hardware support. Further, a memory occupancy for managing an output matrix (feature map) of each layer may be reduced. In the related art DNN model, the memory occupancy size for a corresponding layer-wise output matrix (feature map) is generally larger than a model parameter size. Thus, importance of the channel pruning is being highlighted.

### SUMMARY

There are several types of pruning schemes in the related art as follows: a scheme that removes a link with a small weight value using the fact that a small weight value has a small influence on a final output, and a scheme in which weights having similar values in the same layer are integrated into one link and are subjected to the same computation.

Further, in general, when an original model is pretrained and then set pruning criteria are applied to perform re-training thereof, a link to be removed is determined only with once feed-forward with pretraining the original model. This is referred to as a single-shot based pruning scheme.

In a computing cluster environment including hardware accelerators such as multiple GPUs (graphic processing units) to provide a deep-learning-based service, a resource scheduling technique in which a system operation cost is minimized while satisfying a given service demand level to accommodate service request for multiple users is being studied.

In the related art, for the same purpose, each accelerator resource maximizes throughput while satisfying the service demand level. For this purpose, for example, in a structure that processes deep-learning model inference computation on a batch basis, an optimal batch size to be processed by each resource is searched for and is assigned to an accelerator.

In this regard, a general deep-learning model inference computation latency may be modeled with a linear model based on the batch size. Thus, a maximum batch size to maximize the throughput while satisfying a service processing time constraint as required is searched for and is allocated to each resource.

The related art channel pruning technique focuses mainly on minimizing decrease in accuracy, and performs control based on only how many of all of parameters is reduced.

However, in terms of acceleration of computation, even when the decrease in accuracy may occur by a certain amount, removing a channel with a large computation amount reduction effect may be ultimately more advantageous in terms of accuracy than removing a large number of channels with a small acceleration effect in order to minimize the decrease in accuracy.

In the deep-learning model, the computation amount and memory occupancy characteristics vary in a layer-wise manner. In actual deep-learning model inference serving, in allocating tasks to resources, acceleration of computation may be achieved via reduction of a computation amount through the channel pruning, and an allocable batch size may be increased via reduction of a resource memory occupancy amount of the model.

In resource allocation of the deep-learning model, the resource memory occupancy of layer-wise output matrix (feature map) rather than the memory occupancy of the parameter in general acts as a factor that limits the allocable batch size. Therefore, an efficient pruning scheme that considers the relevant conditions in the pruning process is required.

A purpose of the present disclosure is to provide a deep-learning-based service in a computing cluster environment including multiple hardware accelerators, which may satisfy the service demand level for service requests of given multiple service users, while minimizing the system operating cost.

To achieve this purpose, the present disclosure provides a control scheme based on channel pruning of a deep neural network model that may achieve direct acceleration via channel pruning in utilizing individual resources, increasing the available batch size via gain in terms of memory occupancy of the accelerator resource, thereby increasing the throughput related to the resource.

Specifically, the present disclosure provides a method in which when service performance constraint represented by analysis accuracy and deep-learning-based service computation latency is given at a service demand level, pruning policy by and a batch size at which the maximum throughput is achieved while satisfying the conditions in a specific accelerator resource are determined.

The technical purposes of the present disclosure are not limited to the above-mentioned technical purposes, and other technical purposes not mentioned will be clearly understood by those skilled in the art from the following description.

According to some aspects of the present disclosure, there is provided a control method based on a layer-wise adaptive channel pruning in a deep-learning model computation acceleration, the method including: profiling a layer-wise pruning sensitivity of an original deep-learning model; comparing an influence of a resource memory occupancy reduction on a throughput of an accelerator resource with an influence of a computation amount reduction on the throughput of the accelerator resource; performing, based on a result of the comparing, a channel pruning based on a model layer-wise resource memory occupancy characteristic of the original deep-learning model or based on a model layer-wise computation amount characteristic of the original deep-learning model; in response to the channel-pruned model satisfying a certain model analysis accuracy level, determining a batch size for the accelerator resource; and in response to a throughput of the channel-pruned model based on the determined batch size being greater than a throughput of the original deep-learning model, employing the channel-pruned model in the deep-learning model computation acceleration

According to some aspects of the present disclosure, there is provided a control system based on a layer-wise adaptive channel pruning in a deep-learning model computation acceleration, the system including: at least one processor; and at least one memory configured to store instructions therein, wherein the instructions are executed by the at least one processor to cause the at least one processor to: profile a layer-wise pruning sensitivity of an original deep-learning model; compare an influence of a resource memory occupancy reduction on a throughput of an accelerator resource with an influence of a computation amount reduction on the throughput of the accelerator resource; perform, based on a result of the comparing, a channel pruning based on a model layer-wise resource memory occupancy characteristic of the original deep-learning model or based on a model layer-wise computation amount characteristic of the original deep-learning model; in response to the channel-pruned model satisfying a certain model analysis accuracy level, determine a batch size for the accelerator resource; and in response to a throughput of the channel-pruned model based on the determined batch size being greater than a throughput of the original deep-learning model, employ the channel-pruned model in the deep-learning model computation acceleration.

According to some aspects of the present disclosure, there is provided a non-transitory computer-readable recording medium storing therein a program for performing a control method based on a layer-wise adaptive channel pruning in a deep-learning model computation acceleration, the control method including: profiling a layer-wise pruning sensitivity of an original deep-learning model; comparing an influence of a resource memory occupancy reduction on a throughput of an accelerator resource with an influence of a computation amount reduction on the throughput of the accelerator resource; performing, based on a result of the comparing, a channel pruning based on a model layer-wise resource memory occupancy characteristic of the original deep-learning model or based on a model layer-wise computation amount characteristic of the original deep-learning model; in response to the channel-pruned model satisfying a certain model analysis accuracy level, determining a batch size for the accelerator resource; and in response to a throughput of the channel-pruned model based on the determined batch size being greater than a throughput of the original deep-learning model, employing the channel-pruned model in the deep-learning model computation acceleration.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a flowchart illustrating a control method based on layer-wise adaptive channel pruning according to some embodiments;

FIG. 2 is a flowchart showing a channel pruning method based on model layer-wise memory occupancy characteristics of FIG. 1;

FIG. 3 is a flowchart showing a channel pruning method based on model layer-wise computation amount characteristics of FIG. 1; and

FIG. 4 is a block diagram of an electronic device in a network environment according to some embodiments.

### DETAILED DESCRIPTION

The same reference numbers in different drawings represent the same or similar elements, and as such perform similar functionality. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

It will be understood that, although the terms “first”, “second”, “third”, and so on may be used herein for illustrating various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may actually be executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated.

The features of the various embodiments of the present disclosure may be partially or entirely combined with each other, and may be technically associated with each other or operate with each other. The embodiments may be implemented independently of each other and may be implemented together in an association relationship.

Hereinafter, embodiments according to the technical idea of the present disclosure will be described with reference to the accompanying drawings.

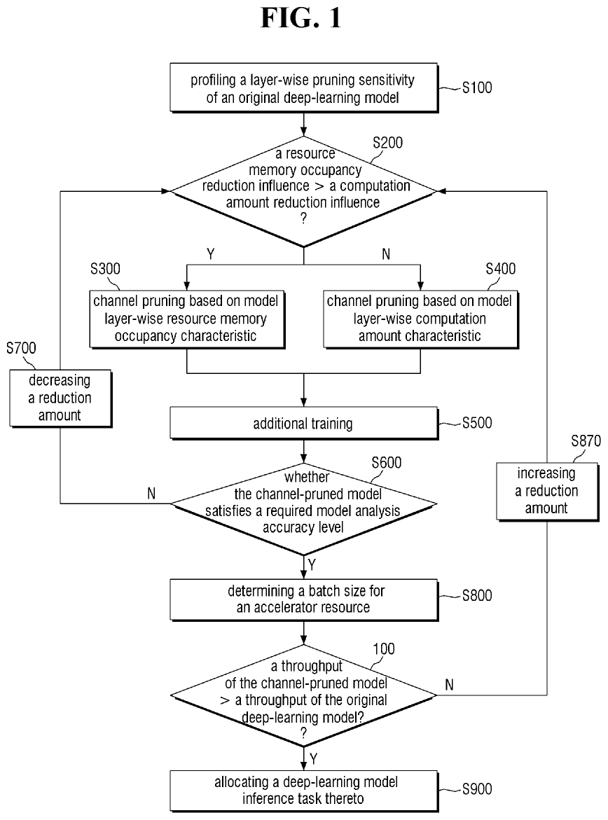

FIG. 1 is a flowchart showing an overall algorithm of a control method based on layer-wise adaptive channel pruning according to some embodiments.

Referring to FIG. 1, the algorithm profiles layer-wise pruning sensitivity related to an original deep-learning model in S100.

For example, in order to obtain profile information on the layer-wise pruning sensitivity related to the deep-learning model to be serviced, an accuracy pattern curve Prᵢ based on a pruning level in a range of 0 to 1 in an i-th layer is obtained in a layer-wise manner from a pre-trained original deep-learning model through testing.

Next, it is identified whether a resource memory occupancy reduction influence on a throughput increase is greater than a computation amount reduction influence on the throughput increase in S200.

When the resource memory occupancy reduction influence is larger than the computation amount reduction influence (S200—Y), channel pruning is performed based on model layer-wise resource memory occupancy characteristics in S300.

When the resource memory occupancy reduction influence is smaller than the computation amount reduction influence (S200—N), channel pruning is performed based on model layer-wise computation amount characteristics in S400.

That is, in inference serving of the model, the influences of the resource memory occupancy amount reduction and the computation amount reduction on the throughput increase may be analyzed and then the channel pruning is performed based on the factor having greater influence.

In this embodiment, a reduction amount may be determined in a layer-wise manner, and a link having the smallest sum of all parameter weights is removed by the reduction amount in each layer. In some embodiments, an initial reduction amount may be set to, for example, 0.5.

In this regard, an overall performance index fₙₑₜ of the network may be calculated in a form of a layer-wise product of an accuracy ratio of a pruned model compared to the original model of each layer, as illustratively expressed in Equation 1 below. A layer-wise pruning level to maximize the index may be searched for.

$${f}_{net} = {\prod }_{i} \frac{{f}_{i} ( {pr}_{i} )}{{f}_{i} ( 0 )} \qquad Equation 1$$

In a structure in which a specific accelerator resource (for example, GPU) processes deep-learning model inference computation on a batch basis, a computation latency l(b) based on a batch size b may be modeled in a form of a linear model of l(b)=αb+β (where α, β∈ [symbol] being a constant).

In this regard, a computation latency acceleration level via the computation amount reduction obtained through the channel pruning is defined as A_{FLOP} (for example, A_{FLOP} times acceleration). An available batch size increase level through the reduction of the resource memory occupancy amount is defined as Aₘₑₘ (for example, Aₘₑₘ increase) (A_{FLOP}, Aₘₑₘ≥0). In this case, under the effect of accelerating the computation processing due to the reduction of the computation amount via the channel pruning, a throughput Thr_{FLOP} at a specific accelerator based on the batch size b, and a throughput influence

$$\frac{\partial {Thr}_{FLOP}}{\partial {A}_{FLOP}}$$

based on the acceleration level expressed in a partial derivative form may be calculated as in Equation 2.

$${Thr}_{FLOP} = \frac{b}{( α b + β )} \cdot {A}_{FLOP} , \qquad Equation 2$$

$$\frac{\partial {Thr}_{FLOP}}{\partial {A}_{FLOP}} = \frac{b}{α b + β}$$

Similarly, under an effect of increasing the available batch size through the resource memory occupancy amount reduction via the channel pruning, a throughput Thrₘₑₘ at the accelerator based on a computation time based on a specific batch size b of the original model and a corresponding batch size b·Aₘₑₘ in the same model as pruned, and a throughput influence

$$\frac{\partial {Thr}_{mem}}{\partial {A}_{mem}}$$

based on an available batch size increase level expressed in a partial derivative form may be calculated as in Equation 3.

$$T h {r}_{mem} = \frac{b \cdot {A}_{mem}}{α b \cdot {A}_{mem} + β} , \qquad Equation 3$$

$$\frac{\partial T h {r}_{m e m}}{\partial {A}_{mem}} = \frac{b β}{{( α b \cdot {A}_{mem} + β )}^{2}}$$

In this regard, the throughput influence

$$\frac{\partial T h {r}_{FLOP}}{\partial {A}_{FLOP}}$$

based on the acceleration level and the throughput influence

$$\frac{\partial T h {r}_{mem}}{\partial {A}_{mem}}$$

based on an available batch size increase level may be compared to each other. Then, the channel pruning is performed based on the characteristics having the larger influence.

As described above, the factor influencing the acceleration and the throughput increase in terms of the deep-learning model inference computation system may include the model memory occupancy amount of the accelerator resource and the model computation amount.

First, the model memory occupancy amount of the accelerator resource may be largely classified into a parameter occupancy size and an occupancy size for managing a layer-wise output matrix (feature map) of the model. In a general convolutional neural network-based deep-learning analysis model, the amount of the memory occupancy for managing the layer-wise output matrix (feature map) of the model occupies a relatively larger proportion. Thus, in an example embodiment, only this characteristic may be considered in determining the model memory occupancy amount.

Accordingly, the memory occupancy amount MO(pr) of the model pruned according to the layer-wise pruning level policy pr=[pr₁, . . . , pr_{L}] may be calculated by summing a layer-wise product of a layer-wise output matrix (feature map) size |xᵢ|₀ and the number nᵢ(1−prᵢ) of remaining outputs from the number nᵢ of output channels of the original model, as shown in Equation 4 below.

$$MO ( pr ) = {\sum }_{i} {\vert {x}_{i} \vert}_{0} {n}_{i} ( 1 - {pr}_{i} ) \qquad Equation 4$$

Similarly, the computation amount CO(pr) expressed in a FLOP (Floating Point Operation) unit of the model pruned according to the layer-wise pruning level policy pr=[pr₁, . . . , pr_{L}] may be calculated by summing a layer-wise product of a layer computation amount COᵢ (expressed in a FLOP (Floating Point Operation) unit) of the original model and ratios (1−prᵢ₋₁). (1−prᵢ) of the numbers of remaining input and output channels after the reduction as shown in Equation 5 below.

$$CO ( pr ) = {\sum }_{i} ( 1 - {pr}_{i - 1} ) ( 1 - {pr}_{i} ) \cdot {CO}_{i} \qquad Equation 5$$

First, in the channel pruning based on the resource memory occupancy amount characteristics, it is necessary to find a layer-wise pruning level pr=[pr₁, . . . , pr_{L}] that maximizes

$${f}_{net} = {\prod }_{i} \frac{{f}_{i} ( {pr}_{i} )}{{f}_{i} ( 0 )}$$

while satisfying a condition MO(pr)=Σᵢ|xᵢ|₀nᵢ(1−prᵢ)≤1/AₘₑₘΣᵢ|xᵢ|₀nᵢ to satisfy the increase Aₘₑₘ in the available batch size of a target value.

To solve this problem, a special condition may be derived using Lagrange Multiplier as in Equation 6.

$$Corresponding dual problem : \qquad Equation 6$$

$$ℒ ( {pr}_{1} , … , {pr}_{L} , λ ) = {\prod }_{i = 1}^{L} \frac{{f}_{i} ( {pr}_{i} )}{{f}_{i} ( 0 )} - λ {\sum }_{i = 1}^{L} {\vert {x}_{i} \vert}_{0} {n}_{i} ( 1 - {pr}_{i} - 1 / {A}_{mem} )$$

$$where$$

$$\begin{matrix}\frac{\partial ℒ}{\partial {pr}_{k}} = {\prod }_{i = 1}^{L} \frac{{f}_{i} ( {pr}_{i} )}{{f}_{i} ( 0 )} \frac{{f}_{i}^{′} ( {pr}_{k} )}{{f}_{i} ( {pr}_{k} )} + λ {\vert {x}_{k} \vert}_{0} {n}_{k} = 0 , & ∀ k ∈\end{matrix} \{ 1 , … , L \}$$

$$Therefore , ∀ k ∈ \{ 1 , … , L \}$$

$$- λ = {\prod }_{i = 1}^{L} \frac{{f}_{i} ( {pr}_{i} )}{{f}_{i} ( 0 )} \frac{{f}_{i}^{′} ( {pr}_{k} )}{{f}_{i} ( {pr}_{k} )} \frac{1}{{\vert {x}_{k} \vert}_{0} {n}_{k}}$$

$$⟹ \frac{{f}_{1}^{′} ( {pr}_{1} )}{{f}_{1} ( {pr}_{1} )} \frac{1}{{\vert {x}_{1} \vert}_{0} {n}_{1}} = … = \frac{{f}_{L}^{′} ( {pr}_{L} )}{{f}_{L} ( {pr}_{L} )} \frac{1}{{\vert {x}_{L} \vert}_{0} {n}_{L}}$$

In this regard, the derived condition may be expressed in a form of a generalized function ƒ_{mem,i}(prᵢ) as in Equation 7. Thus, an optimal pruning policy may be derived based on information obtained in the previous profile step.

$${f}_{mem , i} ( {pr}_{i} ) = \frac{{f}_{i}^{′} ( {pr}_{i} )}{{f}_{i} ( {pr}_{i} )} \frac{1}{{\vert {x}_{i} \vert}_{0} {n}_{i}} \qquad Equation 7$$

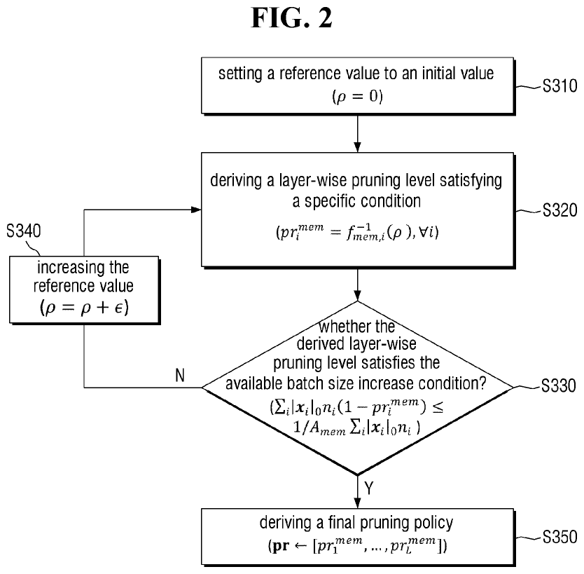

FIG. 2 is a flowchart showing a channel pruning method based on the model layer-wise memory occupancy characteristics of FIG. 1.

Referring to FIG. 2, an initial reference value is set in S310. For example, the initial reference value P may be set to 0.

Then, a layer-wise pruning level that satisfies an optimal specific condition based on a available batch size increase condition is derived in S320.

For example, the layer-wise pruning level prᵢ^{mem} may be derived based on prᵢ^{mem}=ƒ_{mem,t}⁻¹(ρ),∀i.

Next, it is identified whether the derived layer-wise pruning level satisfies the available batch size increase condition in S330.

For example, it is identified whether MO(pr)=Σᵢ|xᵢ|₀nᵢ(1−prᵢ)≤1/AₘₑₘΣᵢ|xᵢ|₀nᵢ is satisfied in S330. When MO(pr)=Σᵢ|xᵢ|₀nᵢ(1−prᵢ)≤1/AₘₑₘΣᵢ|xᵢ|₀nᵢ is not satisfied (S330—N), a reference value may be increased in S340. Then, the algorithm derives the layer-wise pruning level again in S320.

When the derived layer-wise pruning level satisfies the available batch size increase condition (S330—Y), a final pruning policy is derived in S350.

In the channel pruning based on the inference computation amount characteristics of the deep-learning model, it is necessary to find a layer-wise pruning level pr=[pr₁, . . . , pr_{L}] that maximizes

$${f}_{net} = {\prod }_{i} \frac{{f}_{i} ( {pr}_{i} )}{{f}_{i} ( 0 )}$$

while satisfying a condition CO(pr)=Σᵢ(1−prᵢ₋₁)(1−prᵢ)·COᵢ≤1/A_{FLOP}ΣᵢCOᵢ to satisfy the model inference computation latency acceleration level A_{FLOP} via the computation amount reduction by the target value.

To solve this problem, a special condition may be derived using Lagrange Multiplier as in Equation 8.

$$Corresponding dual problem : \qquad Equation 8$$

$$ℒ ( {pr}_{1} , … , {pr}_{L} , λ ) = {\prod }_{i = 1}^{L} \frac{{f}_{i} ( {pr}_{i} )}{{f}_{i} ( 0 )} - λ {\sum }_{i = 1}^{L} {CO}_{i} ( ( 1 - {pr}_{i} ) ( 1 - {pr}_{i - 1} ) - 1 / {A}_{Flop} )$$

$$where$$

$$\begin{matrix}\frac{\partial ℒ}{\partial {pr}_{k}} = {\prod }_{i = 1}^{L} \frac{{f}_{i} ( {pr}_{i} )}{{f}_{i} ( 0 )} \frac{{f}_{i}^{′} ( {pr}_{k} )}{{f}_{i} ( {pr}_{k} )} + λ {CO}_{k} ( 1 - {pr}_{k - 1} ) = 0 , & ∀ k ∈\end{matrix} \{ 1 , … , L \}$$

$$Therefore , ∀ k ∈ \{ 1 , … , L \}$$

$$- λ = {\prod }_{i = 1}^{L} \frac{{f}_{i} ( {pr}_{i} )}{{f}_{i} ( 0 )} \frac{{f}_{k}^{′} ( {pr}_{k} )}{{f}_{k} ( 0 )} \frac{1}{{CO}_{k} ( 1 - {pr}_{k - 1} )}$$

$$⟹ \frac{{f}_{1}^{′} ( {pr}_{1} )}{{f}_{1} ( {pr}_{1} )} \frac{1}{{CO}_{1} ( 1 - {pr}_{0} )} = … = \frac{{f}_{L}^{′} ( {pr}_{L} )}{{f}_{L} ( {pr}_{L} )} \frac{1}{{CO}_{L} ( 1 - {pr}_{L - 1} )} , {pr}_{0} = 0$$

In this regard, regarding the derived condition, pr₀=0. Thus, pruning level values of the remaining layers except for a first layer may be sequentially determined based on a pruning level of the first layer.

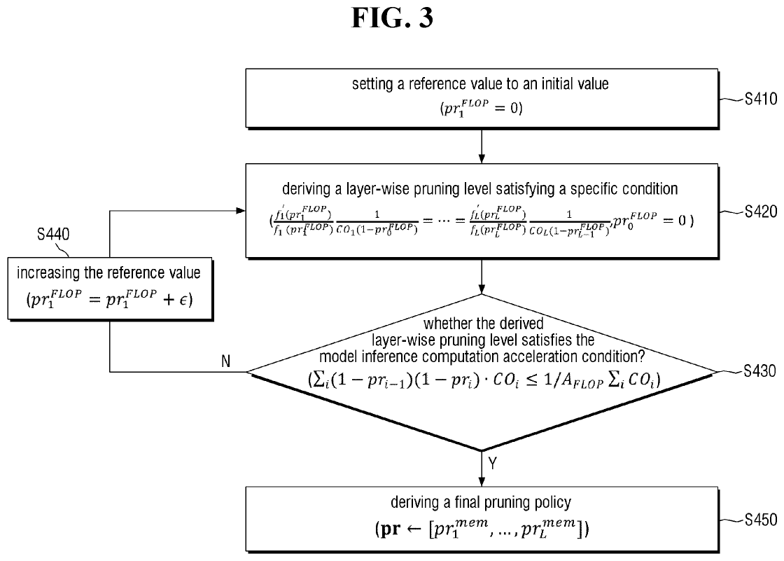

FIG. 3 is a flowchart showing the channel pruning method based on the model layer-wise computation amount characteristics of FIG. 1.

Referring to FIG. 3, in S410, a first layer pruning level may be set. For example, the first layer pruning level may be set to 0.

Then, a layer-wise pruning level that satisfies an optimal specific condition considering a model inference computation acceleration condition is derived in S420.

For example, the layer-wise pruning level may be derived using a following equation.

$$\frac{{f}_{1}^{′} ( {pr}_{1}^{FLOP} )}{{f}_{1} ( {pr}_{1}^{FLOP} )} \frac{1}{{CO}_{1} ( 1 - {pr}_{0}^{FLOP} )} = … = \frac{{f}_{L}^{′} ( {pr}_{L}^{FLOP} )}{{f}_{L} ( {pr}_{L}^{FLOP} )} \frac{1}{{CO}_{L} ( 1 - {pr}_{L - 1}^{FLOP} )} , {pr}_{0}^{FLOP} = 0$$

Next, it is identified whether the derived layer-wise pruning level satisfies the model inference computation acceleration condition in S430.

For example, it may be identified whether Σᵢ(1−prᵢ₋₁)(1−prᵢ)·COᵢ≤1/A_{FLOP}ΣᵢCOᵢ is satisfied in S430. When Σᵢ(1−prᵢ₋₁)(1−prᵢ)·COᵢ≤1/A_{FLOP}ΣᵢCOᵢ is not satisfied (S430—N), the algorithm increases a reference value in S440, and then derives the layer-wise pruning level again in S420.

When the derived layer-wise pruning level satisfies the model inference computation acceleration condition (S430—Y), a final pruning policy is derived in S450.

Referring back to FIG. 1, if necessary, additional training (fine tuning) is performed on the channel-pruned model subjected to the channel pruning step in S500.

Then, it is identified whether the channel-pruned model satisfies a required model analysis accuracy level in S600.

When the channel-pruned model does not satisfy the required accuracy level (S600—N), the reduction amount is lowered in S700.

For example, the reduction amount 0.5 previously set to the initial value may be reduced to half thereof, that is, 0.25. Then, a process including and after S200 is performed again.

When the channel-pruned model satisfies the required accuracy level (S600—Y), the optimal batch size for inference computation distribution in the channel-pruned model is determined in S800.

For example, a maximum batch size that may be used to maximize the throughput under the condition that satisfies the inference computation time latency constraint may be determined.

In this regard, assuming that the optimal (maximum) batch size that satisfies the inference computation latency constraint in the original model is defined as bₘₐₓ^{ori}, an optimal batch size bₘₐₓ^{pr} related to the model as pruned under the available batch size increase effect

$$\frac{{\sum }_{i} {\vert {x}_{i} \vert}_{0} {n}_{i}}{{\sum }_{i} {\vert {x}_{i} \vert}_{0} {n}_{i} ( 1 - {pr}_{i} )}$$

resulting from the resource memory occupancy amount as reduced via the previous channel pruning operation may be calculated based on Equation 9.

$${b}_{max}^{pr} = ⌊ \frac{{\sum }_{i} {\vert {x}_{i} \vert}_{0} {n}_{i}}{{\sum }_{i} {\vert {x}_{i} \vert}_{0} {n}_{i} ( 1 - {pr}_{i} )} \cdot {b}_{max}^{ori} ⌋ \qquad Equation 9$$

Next, the throughput of the channel-pruned model may be compared with the throughput of the original model in S850. When the throughput of the channel-pruned model is smaller than that of the original model (S850—N), the algorithm increase the reduction amount in S870.

When the throughput of the channel-pruned model is larger than that of the original model (S850—Y), the channel-pruned model is determined based on the determined setting, and then the deep-learning model inference task is assigned thereto in S900.

For example, the throughput at the optimal batch size bₘₐₓ^{pr} of the pruned model to which the computation acceleration effect

$$\frac{{\sum }_{i} {CO}_{i}}{{\sum }_{i} ( 1 - p {r}_{i - 1} ) ( 1 - {pr}_{i} ) \cdot {CO}_{i}}$$

based on the model inference computation amount reduced through the channel pruning step has been applied may be calculated based on Equation 10.

$$T h {r}_{max}^{p r} = \frac{{b}_{max}^{pr}}{( α {b}_{max}^{p r} + β )} \cdot \frac{{\sum }_{i} {CO}_{i}}{{\sum }_{i} ( 1 - p {r}_{i - 1} ) ( 1 - p {r}_{i} ) \cdot {CO}_{í}} \qquad Equation 10$$

Thus, the throughput in the original model setting and the throughput in the currently derived setting are compared with each other. When the throughput based on the new policy is relatively larger, the pruned model is allocated and redistributed to the resource (for example, an accelerator).

When the throughput of the new policy is relatively smaller, the algorithm increases the computation characteristics reduction amount applied in the channel pruning step so that a remaining reduction margin of a current set value is reduced to half thereof. The increased reduction amount may be applied and re-searching may be done. In this way, the channel pruning-based control may be performed so as to increase the deep-learning model inference computation throughput of the resource (e.g., accelerator).

In this way, the method according to the present disclosure may increase the available batch size in the individual resource, for example, the accelerator to increase throughput thereof, and may achieve the effect of accelerating the deep-learning model inference computation, thereby satisfying the processing latency at the service demand level.

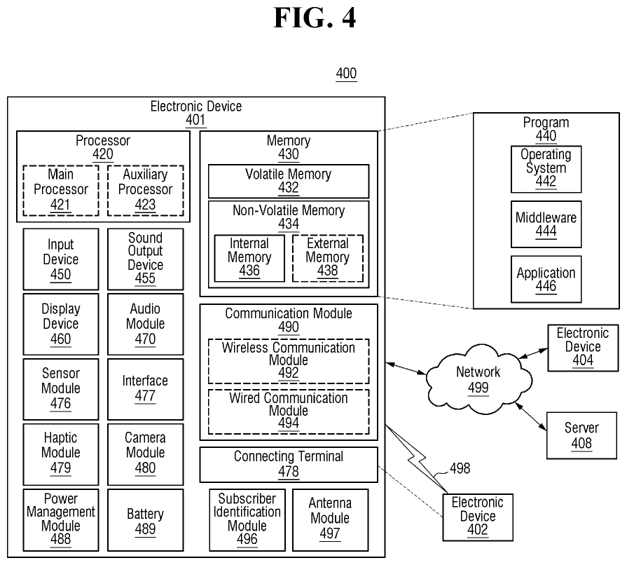

FIG. 4 is a block diagram of an electronic device in a network environment according to some embodiments.

In some embodiments, the electronic device or electronic system shown in FIG. 4 may be used to implement the control method based on the layer-wise adaptive channel pruning as above-described. Further, in some embodiments, the electronic device or electronic system shown in FIG. 4 may be used to execute the pruned model derived according to the control method based on the layer-wise adaptive channel pruning as above-described.

An electronic device 401 in a network environment 400 communicates with an electronic device 402 over a first network 498 such as a short-range wireless communication network, or with an electronic device 404 or a server 408 over a second network 499 such as a long-range wireless communication network.

The electronic device 401 may communicate with the electronic device 404 via the server 408. The electronic device 401 may include a processor 420, a memory 430, an input device 450, a sound output device 455, an image display device 460, an audio module 470, a sensor module 476, an interface 477, a haptic module 479, a camera module 480, a power management module 488, a battery 489, a communication module 490, a subscriber identification module (SIM) 496 or an antenna module 497.

In some embodiments, for example, at least one of components such as the display device 460 or the camera module 480 may be omitted from the electronic device 401, or at least one further component may be added to the electronic device.

In some embodiments, some of the components may be implemented as a single integrated circuit (IC). For example, the sensor module 476 such as a fingerprint sensor, an iris sensor, and an illuminance sensor may be embedded in an image display device such as a display.

The processor 420 may execute software (for example, a program 440) that controls other components of at least one electronic device 401 such as a hardware or software component connected to the processor 420 to perform various data processing and computations. The processor 420 may include one or more processors to perform processing and computations according to the method described above in FIGS. 1-3.

Under data processing or at least some of computations, the processor 420 may load a command or data received from another component such as the sensor module 476 or the communication module 490 into a volatile memory 432, and process the command or data stored in the volatile memory 432, and store resulting data in a non-volatile memory 434.

The processor 420 may include, for example, a main processor 421 such as a central processing unit (CPU) or a smartphone application processor (AP) and an auxiliary processor 423 operating independently of the main processor 421 or in connection with the main processor 421.

The auxiliary processor 423 may include, for example, a graphic processing unit (GPU), an image signal processor (ISP), a sensor hub processor, or a communication processor (CP), etc. The graphic processing unit may act as an accelerator for processing the original model or the pruned model as described above.

In some embodiments, the auxiliary processor 423 may be configured to consume less power or than that of the main processor 421 or perform certain functions. The auxiliary processor 423 may be separate from the main processor 421 or implemented as a portion thereof.

The auxiliary processor 423 may control at least some of functions or states related to at least one of the components of the electronic device 401 on behalf of the main processor 421 while the main processor 421 is inactive, or together with the main processor 421 while the main processor 421 is active.

The memory 430 may store therein various data used in at least one component of the electronic device 401. The various data may include, for example, software such as the program 440, and input data and output data for related commands. The memory 430 may include the volatile memory 432 and the non-volatile memory 434.

The program 440 may be stored as software in the memory 430, and may include, for example, an operating system (OS) 442, middleware 1044, or an application 1046.

The control method based on the layer-wise adaptive channel pruning as described above may be implemented in a form of the program 440 and stored in the memory 430.

The input device 450 may receive a command or data to be used for other components of the electronic device 401 from a device external to the electronic device 401. The input device 450 may include, for example, a microphone, mouse, or keyboard.

The sound output device 455 may output a sound signal out of the electronic device 401. The sound output device 455 may include, for example, a speaker or a receiver. The speaker may be used for general purpose of playing multimedia or recording a sound. The receiver may be used to receive an incoming call.

The image display device 460 may visually provide information out of the electronic device 401. The image display device may include, for example, a display, a hologram device, or a projector, and a control circuit for controlling a corresponding one of the display, the hologram device, or the projector.

In some embodiments, the image display device 460 may include a touch circuit configured to detect a touch, or a sensor circuit configured to measure intensity of a force induced by the touch, for example, a pressure sensor.

The audio module 470 may convert a sound into an electrical signal or vice versa. In some embodiments, the audio module 470 may obtain a sound via the input device 450 or output the sound via the sound output device 405 or a headphone of an external electronic device 402 directly or wirelessly connected to the electronic device 401.

The sensor module 476 may detect, for example, an operating state of the electronic device 401 such as output or temperature, or an environmental state external to the electronic device 401 such as a user's state, and may generate an electrical signal or data corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support at least one prescribed protocol to be used by the electronic device 401 directly or wirelessly connected to the external device 402. In some embodiments, the interface 477 may include, for example, a high definition multimedia interface (HDMI), an universal serial bus (USB) interface, a secure digital (SD) card interface, or a voice interface.

A connection terminal 478 may include a connector through which the electronic device 401 may be physically connected to the external electronic device 402. In some embodiments, the connection terminal 478 may include, for example, an HDMI connector, a USB connector, an SD card connector, or a voice connector such as a headphone connector.

The haptic module 479 may convert an electrical signal into a mechanical stimulus, for example, vibration or motion, which may be recognized by a user via a haptic sensation or a kinesthetic sensation. In some embodiments, the haptic module 479 may include, for example, a motor, a piezoelectric element, or an electrical stimulator.

The camera module 480 may capture still images or moving images. In some embodiments, the camera module 480 may include at least one lens, an image sensor, an image signal processor, or a flash.

The power management module 488 may manage power supplied to the electronic device 401. The power management module may be implemented, for example, as at least a portion of a power management integrated circuit (PMIC).

The battery 489 may supply power to at least one component of the electronic device 401. According to an embodiment, the battery 489 may include, for example, a non-rechargeable primary battery, a rechargeable secondary battery, or a fuel cell.

The communication module 490 may support establishment of a direct communication channel or a wireless communication channel between the electronic device 401 and an external electronic device such as, for example, the electronic device 402, the electronic device 404, or the server 408, and communicate therewith via the established communication channel.

The communication module 490 may operate independently of the processor 420, and may include at least one communication processor supporting direct communication or wireless communication.

In some embodiments, the communication module 490 may include, for example, a wireless communication module 492 such as a mobile communication (cellular communication module), a short-range wireless communication module, or a global navigation satellite system (GNSS) communication module, or a wired communication module 494 such as a local area network (LAN) communication module, or a power line communication (PLC) module.

A corresponding communication module among these communication modules may communicate with an external electronic device over the first network 498 such as, for example, blue-tooth Bluetooth™, Wi-Fi (wireless-fidelity), direct or IrDA (standard of the Infrared Data Association) or the second network 499 such as, for example, the mobile communication network, the Internet, and the long-range communication network.

These various types of communication modules may be implemented, for example, as a single component or as a plurality of components separated from each other. The wireless communication module 492 may use, for example, subscriber information such as international mobile subscriber identity (IMSI) stored in the user identification module 496 to identify and authenticate the electronic device 401 in a communication network such as the first network 498 or the second network 499.

The antenna module 497 may transmit or receive a signal or power to or from a device external to the electronic device 401. In some embodiments, the antenna module 497 may include at least one antenna. Thus, at least one antenna suitable for a communication scheme used in a communication network such as the first network 498 or the second network 499 may be selected by the communication module 490. Then, the signal or power may be transmitted or received between the communication module and the external electronic device via the selected at least one antenna.

At least some of the aforementioned components may be interconnected to each other, and may communicate a signal therebetween in an inter-peripheral communication scheme such as, for example, a bus, a general purpose input and output (GPIO), a serial peripheral interface (SPI), or a mobile industry processor interface (MIPI).

In some embodiments, the command or data may be transmitted or received between the electronic device 401 and the external electronic device 404 via the server 408 connected to the second network 499. Each of the electronic devices 402 and 404 may be of the same type as or a different type from that of the electronic device 401. All or some of the operations to be executed on the electronic device 401 may be executed on at least one external electronic device 402, 404, or 408. For example, all or some of the operations to be executed on the electronic device 401 may be executed on at least one external electronic device 402, 404, or 408.

For example, when the electronic device 401 is configured to perform a function or service automatically or in response to a request from a user or other device, the electronic device 401 executing the function or service may request at least one external electronic device to perform at least a portion of the function or service instead or in addition to the device 401. At least one external electronic device that has received the request may perform at least a portion of the requested function or service or an additional function or additional service related to the request, and transmit a result of the execution to the electronic device 401. The electronic device 401 provides the result as at least a portion of a response to the request with or without further processing of the result. For this purpose, for example, cloud computing, distributed computing, or client-server computing technologies may be used.

The steps as described above with reference to FIG. 1 to FIG. 3 may be implemented in software, for example, the program 440, etc. including at least one instruction stored in a machine-readable storage medium, for example, an internal memory 436 or an external memory 438.

For example, the processor 420 of the electronic device 401 may invoke at least some of at least one instruction stored in the storage medium and may execute the invoked instruction with or without use of at least one other component under the control of the processor 420.

Accordingly, the device (for example, the electronic device 401) may be configured to perform at least one function according to the at least one invoked instruction. At least one instruction may include code generated by a compiler or code that may be executed by an interpreter.

The machine-readable storage medium may be provided in a form of a non-volatile storage medium. Although the term “non-transitory” indicates that the storage medium is a tangible device and does not include a signal such as an electromagnetic wave. However, this term does not distinguish a case in which data is stored semi-permanently in the storage medium from a case in which data is temporarily is stored in the storage medium.

In some embodiments, the steps described with reference to FIG. 1 to FIG. 3 above may be distributed while being included in a computer program product. This computer program product may be traded as a product between a seller and a buyer. This computer program product may be distributed in a form of a machine-readable storage medium, for example, a compact disc read only memory (CD-ROM), or for example, online via an application store such as Play Store, or may be directly distributed between two user devices such as smartphones.

When the product is distributed online, at least a portion of the computer program product may be temporarily created or at least temporarily stored in a machine-readable storage medium, such as a memory of a manufacturer's server, an app store's server, or a relay server.

In some embodiments, each of the aforementioned components, such as, for example, the module or the program may include a single entity or a plurality of entities. At least one of the above-described components may be omitted or at least one further component may be added. Alternatively or additionally, a plurality of components, for example, a plurality of modules or programs may be integrated into a single component. In this case, the integrated component may still perform at least one function of each of the plurality of components in the same or similar scheme as or to the scheme in which the function is performed using a corresponding one of the plurality of components before the integration. The operations performed by the module, the program, or another component may be executed sequentially, parallel, iteratively, or heuristically, or at least one of the operations may be executed or omitted in a different order, or at least one further operation may be added.

Although embodiments of the present disclosure have been described with reference to the accompanying drawings, the present disclosure is not limited to the above embodiments and may be executed in various different forms. Thus, a person with ordinary skill in the technical field to which the present disclosure belongs will be able to understand that the present disclosure may be implemented in other specific forms without changing the technical idea or essential characteristics of the present disclosure. Therefore, it should be understood that the embodiments as described above are illustrative in all respects and not restrictive.

What is claimed is:

1. A control method based on a layer-wise adaptive channel pruning in a deep-learning model computation acceleration, the method comprising:
profiling a layer-wise pruning sensitivity of an original deep-learning model;
comparing an influence of a resource memory occupancy reduction on a throughput of an accelerator resource with an influence of a computation amount reduction on the throughput of the accelerator resource;
performing, based on a result of the comparing, a channel pruning based on a model layer-wise resource memory occupancy characteristic of the original deep-learning model or based on a model layer-wise computation amount characteristic of the original deep-learning model;
in response to the channel-pruned model satisfying a certain model analysis accuracy level, determining a batch size for the accelerator resource; and
in response to a throughput of the channel-pruned model based on the determined batch size being greater than a throughput of the original deep-learning model, employing the channel-pruned model in the deep-learning model computation acceleration.

2. The method of claim 1, wherein the performing the channel pruning includes:
based on the influence of the resource memory occupancy reduction being greater than the influence of the computation amount reduction, performing the channel pruning based on the model layer-wise resource memory occupancy characteristic; or based on the influence of the resource memory occupancy reduction being not greater than the influence of the computation amount reduction, performing the channel pruning based on the model layer-wise computation amount characteristic.

3. The method of claim 1, wherein the performing the channel pruning based on the model layer-wise resource memory occupancy characteristic includes:
setting a reference value to an initial value;
deriving a layer-wise pruning level satisfying a specific condition;
based on the derived layer-wise pruning level satisfying an available batch size increase condition, deriving a final pruning policy, wherein the available batch size increase condition is a condition to increase an available batch size increase level via the resource memory occupancy reduction by a target value; and
performing the channel pruning based on the model layer-wise resource memory occupancy characteristic under the final pruning policy.

4. The method of claim 3, further comprising, based on the derived layer-wise pruning level not satisfying the available batch size increase condition, increasing the reference value and performing the deriving based on the increased reference value.

5. The method of claim 1, wherein the performing the channel pruning based on the model layer-wise computation amount characteristic includes:
setting a reference value to an initial value;
deriving a layer-wise pruning level satisfying a specific condition;
based on the derived layer-wise pruning level satisfying a model inference computation acceleration condition, deriving a final pruning policy, wherein the model inference computation acceleration condition is a condition to increase a model inference computation latency acceleration level via the computation amount reduction by a target value; and
performing the channel pruning based on the model layer-wise computation amount characteristic under the final pruning policy.

6. The method of claim 5, further comprising, based on the derived layer-wise pruning level not satisfying the model inference computation acceleration condition, increasing the reference value and deriving the layer-wise pruning level based on the increased reference value.

7. The method of claim 1, further comprising performing an additional training on the channel-pruned model.

8. The method of claim 1, further comprising, based on the channel-pruned model not satisfying the certain model analysis accuracy level, decreasing a reduction amount in the resource memory occupancy reduction or in the computation amount reduction.

9. The method of claim 1, further comprising, in response to the throughput of the channel-pruned model based on the determined batch size being not greater than the throughput of the original deep-learning model, increasing a reduction amount in the resource memory occupancy reduction or in the computation amount reduction.

10. A control system based on a layer-wise adaptive channel pruning in a deep-learning model computation acceleration, the system comprising:
at least one processor; and
at least one memory configured to store instructions therein,
wherein the instructions are executed by the at least one processor to cause the at least one processor to:
profile a layer-wise pruning sensitivity of an original deep-learning model;
compare an influence of a resource memory occupancy reduction on a throughput of an accelerator resource with an influence of a computation amount reduction on the throughput of the accelerator resource;
perform, based on a result of the comparing, a channel pruning based on a model layer-wise resource memory occupancy characteristic of the original deep-learning model or based on a model layer-wise computation amount characteristic of the original deep-learning model;
in response to the channel-pruned model satisfying a certain model analysis accuracy level, determine a batch size for the accelerator resource; and
in response to a throughput of the channel-pruned model based on the determined batch size being greater than a throughput of the original deep-learning model, employ the channel-pruned model in the deep-learning model computation acceleration.

11. The system of claim 10, wherein the instructions are executed by the at least one processor to further cause the at least one processor to:
based on the influence of the resource memory occupancy reduction being greater than the influence of the computation amount reduction, perform the channel pruning based on the model layer-wise resource memory occupancy characteristic; or
based on the influence of the resource memory occupancy reduction being not greater than the influence of the computation amount reduction, perform the channel pruning based on the model layer-wise computation amount characteristic.

12. The system of claim 10, wherein the instructions are executed by the at least one processor to further cause the at least one processor to:
set a reference value to an initial value;
derive a layer-wise pruning level satisfying a specific condition;
based on the derived layer-wise pruning level satisfying an available batch size increase condition, derive a final pruning policy, wherein the available batch size increase condition is a condition to increase an available batch size increase level via the resource memory occupancy reduction by a target value; and
perform the channel pruning based on the model layer-wise resource memory occupancy characteristic under the final pruning policy.

13. The system of claim 12, wherein the instructions are executed by the at least one processor to further cause the at least one processor to, based on the derived layer-wise pruning level not satisfying the available batch size increase condition, increase the reference value and derive the layer-wise pruning level based on the increased reference value.

14. The system of claim 10, wherein the instructions are executed by the at least one processor to further cause the at least one processor to:
set a reference value to an initial value;
derive a layer-wise pruning level satisfying a specific condition;
based on the derived layer-wise pruning level satisfying a model inference computation acceleration condition, derive a final pruning policy, wherein the model inference computation acceleration condition is a condition to increase a model inference computation latency acceleration level via the computation amount reduction by a target value; and
perform the channel pruning based on the model layer-wise computation amount characteristic under the final pruning policy.

15. The system of claim 14, wherein the instructions are executed by the at least one processor to further cause the at least one processor to: based on the derived layer-wise pruning level not satisfying the model inference computation acceleration condition, increase the reference value and derive the layer-wise pruning level based on the increased reference value.

16. The system of claim 10, wherein the instructions are executed by the at least one processor to further cause the at least one processor to performing additional training on the channel-pruned model.

17. The system of claim 10, wherein the instructions are executed by the at least one processor to further cause the at least one processor to: based on the channel-pruned model not satisfying the certain model analysis accuracy level, decrease a reduction amount in the resource memory occupancy reduction or in the computation amount reduction.

18. The system of claim 10, wherein the instructions are executed by the at least one processor to further cause the at least one processor to: in response to the throughput of the channel-pruned model based on the determined batch size being not greater than the throughput of the original deep-learning model, increase a reduction amount in the resource memory occupancy reduction or in the computation amount reduction.

19. A non-transitory computer-readable recording medium storing therein a program for performing a control method based on a layer-wise adaptive channel pruning in a deep-learning model computation acceleration, the control method comprising:
profiling a layer-wise pruning sensitivity of an original deep-learning model;
comparing an influence of a resource memory occupancy reduction on a throughput of an accelerator resource with an influence of a computation amount reduction on the throughput of the accelerator resource;
performing, based on a result of the comparing, a channel pruning based on a model layer-wise resource memory occupancy characteristic of the original deep-learning model or based on a model layer-wise computation amount characteristic of the original deep-learning model;
in response to the channel-pruned model satisfying a certain model analysis accuracy level, determining a batch size for the accelerator resource; and
in response to a throughput of the channel-pruned model based on the determined batch size being greater than a throughput of the original deep-learning model, employing the channel-pruned model in the deep-learning model computation acceleration.

20. The non-transitory computer-readable recording medium of claim 19, wherein the method further comprises:
in response to the channel-pruned model not satisfying the certain model analysis accuracy level, decreasing a reduction amount in the resource memory occupancy reduction or in the computation amount reduction; and
in response to the throughput of the channel-pruned model based on the determined batch size being not greater than the throughput of the original deep-learning model, increasing the reduction amount in the resource memory occupancy reduction or in the computation amount reduction.
